(19) United States
(12) Patent Application Publication
(10) Pub. No.: US 2006/0078309 A1
(43) Pub. Date: Apr. 13, 2006

(54) Home monitoring digital video recorder (DVR)

(76) Inventors: Shan Jang Chen, Jubei City (TW); Pao Chyuan Chen, Jubei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/960,908

(22) Filed: Oct. 12, 2004

(51) Int. Cl. H04N 5/76; H04N 5/781

(52) U.S. Cl. 386/117; 386/125

(57) ABSTRACT

A digital video recorder makes use of a flash memory for storage of A/V data to accomplish multiple times of read/write. A programmable digital signal processing (DSP) chip is also provided to integrate various circuits with different functions in a modular way to decrease the number of chips, lower the cost, and increase the reliability. Moreover, the DSP chip can monitor the actions of video playback/recording without connection to an external computer, hence accomplishing easy operation without complex setting. There is also a built-in video recognition trigger mechanism, which can be replaced by an external personal infrared (PIR) circuit to trigger recording actions only when an event takes place. A small-size, low-price digital video recorder of easy installation and high reliability can thus be provided, and can effectively save power to be suitable for home use.

### FIELD OF THE INVENTION

The present invention relates to a digital video recorder and, more particularly, to a digital video recorder used for home security.

### BACKGROUND OF THE INVENTION

Monitor systems can offer much security for property and life of people. Along with continual progress of science and technology, conventionally complex and expensive devices have gradually become consumer electronic products now. Monitor devices originally used in large institutions or military facilities have gradually been applied in common families due to progress in electronics so that common families can utilize safety protection mechanisms of simple operation and economic price.

A conventional monitoring digital video recorder records continuous frames, which are finally sent to a device like a video tape or a harddisk drive, a CD-R, a CD-RW, a DVD-R, or a DVD-RW of a computer for storage of video data. A normal video tape, however, can only record for about 1000 times, and has only a small storage capacity. Although a harddisk drive has a large storage capacity, its number of read/write cycles is less than 1000. Various optical discs have the disadvantage that they aren't rewritable. Moreover, the optical disc devices required for read/write of optical discs have a complex structure and a high cost, hence being not suitable for common home use. Therefore, there is much limit in use of digital video recorder.

As shown in FIG. 1, after a conventional monitoring digital video recorder captures continual frames and audio via a security camera 12, the signals are sent to a digital video recorder 10, received by a video ADC 101 and an audio CODEC 102, and processed by an A/V signal compression chip 103 and then by a central processor 104. Next, the central processor 104 stores the A/V data into a harddisk 105 or sends the A/V data to a display 16 via a video encoder 107 and an audio CODEC 108. Therefore, the conventional monitor digital video recorder has a complex structure. Each function is carried out by an independent unit or chip. A system engineer is required for setting of the whole safety device to cause increase of the installation cost so that a common family can't afford the expense and maintenance cost.

Accordingly, the present invention aims to propose a digital monitor video recorder to solve the above problems in the prior art.

### SUMMARY AND OBJECTS OF THE PRESENT INVENTION

An object of the present invention is to provide a digital video recorder, which uses a flash memory for storage of data. The digital video recorder has a small size, has a low power consumption demand, radiates less heat, has a long lifetime of use, and is difficult to damage.

Another object of the present invention is to provide a digital video recorder making use of circuit integration design to integrate various chips with different functions together to provide a small-size and low-cost digital video recorder, which is suitable for common home use.

Another object of the present invention is to provide a digital video recorder, which integrates various devices together to save connection interfaces of different devices. Moreover, the digital video recorder can plug and play to avoid difficulty in installation and use.

Another object of the present invention is to provide a digital video recorder, which makes use of a built-in video recognition system to automatically activate video and audio recording functions when an event takes place. It is not necessary to keep recording for the whole day, hence avoiding unnecessary devices and power consumption.

According to the present invention, a digital monitor video recorder comprises a flash memory for storage of A/V data and an IC chip. The IC chip is a programmable digital signal processing (DSP) chip, which integrates various circuits of different functions. The IC chip comprises a video signal conversion circuit for converting an analog video signal into a digital video signal, an audio signal conversion circuit for converting an analog audio signal into a digital audio signal, a signal compression circuit for comprising the digital video signal and audio signal, a video recognition trigger mechanism, and a USB interface circuit for connection with an external device.

The various objects and advantages of the present invention will be more readily understood from the following detailed description when read in conjunction with the appended drawings, in which:

### BRIEF DESCRIPTION OF DRAWING

FIG. 1 is a structure block diagram of the prior art;

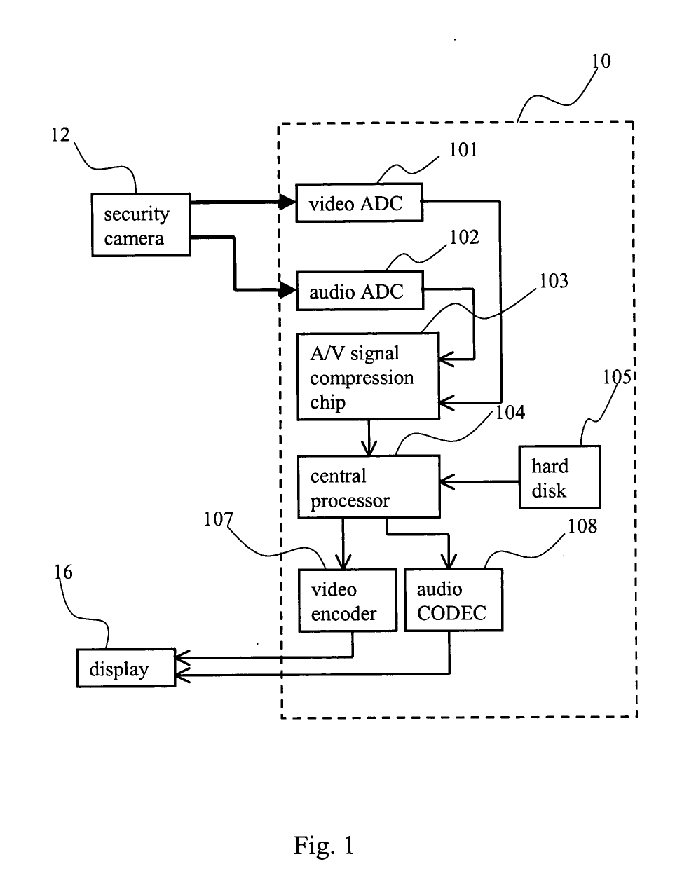

FIG. 2 is a structure block diagram of the present invention; and

FIG. 3 is another structure block diagram of the present invention.

### DETAILED DESCRIPTION OF PREFERRED EMBODIMENT

The present invention makes use of a flash memory for storage of data of a digital video recorder and integrates circuits to shrink the size and lower the cost of the digital monitor video recorder.

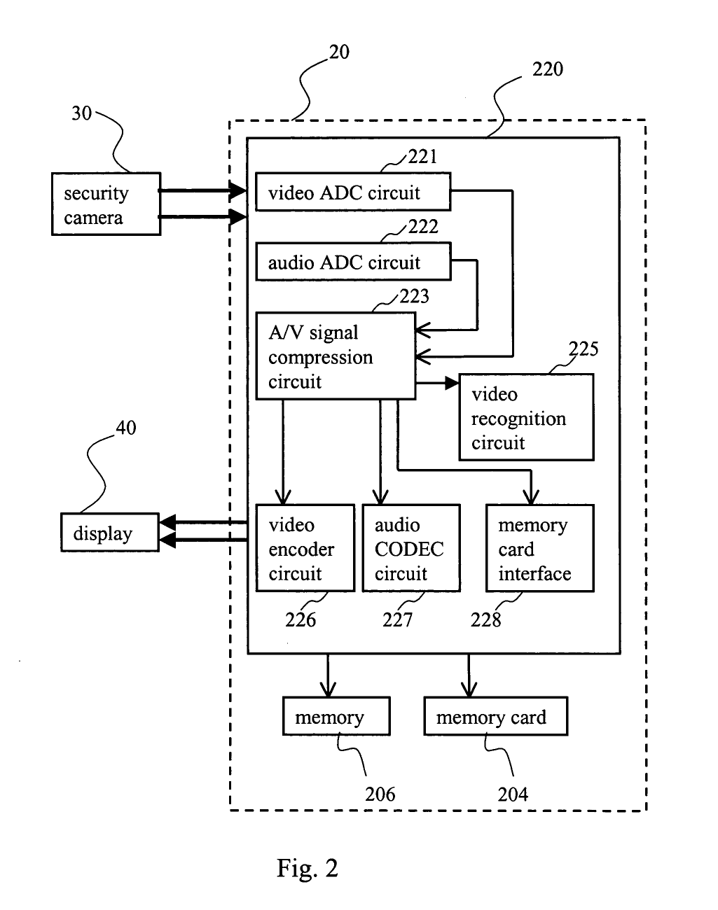

As shown in FIG. 2, a digital video recorder 20 is connected with a security camera 30 via an analog video signal input port and an analog audio signal input port. The micro CPU 30 is used to monitor an area. The digital video recorder 20 has also an analog video signal output port and an analog audio signal output port for connection with a display 40. The digital video recorder 20 comprises a programmable digital signal processing (DSP) chip 220, a memory 206, and a memory card 204. The DSP chip 220 is used to fast process digital signals. The memory 206 can store temporary data during operations of the DSP chip 220. The memory card 204 can store permanent files. The DSP chip 220 has also several circuits with different functions embedded therein, including a video ADC circuit 221 used to convert an analog video signal into a digital one, an audio ADC circuit 222 used to convert an analog audio signal into a digital one, a A/V signal compression circuit 223 used to compress digital signals, a video recognition circuit 225 used to determine whether there is an event taking place in the monitored area and capable of activating the recording function, a video encoder circuit 226 for converting the digital video signal into a signal suitable for playback on the display, an audio CODEC circuit 227 for converting the digital audio signal into a signal suitable for playback on a loudspeaker, and a universal serial bus (USB) interface circuit (not shown) for connection with an external device.

When the digital video recorder 20 performs recording, the external security camera 30 captures vision and audio of a monitored area and converts the vision into an analog video signal and the audio into an analog audio signal. The analog video signal is sent to the DSP chip 220 via the analog video signal input port and is then converted into a digital video signal by the video ADC circuit 221. The analog audio signal is sent to the DSP chip 220 via the analog audio signal input port and is then converted into a digital audio signal by the audio ADC circuit 222. Next, the signal compression circuit 223 compresses the digital video signal and the digital audio signal into digital A/V data with a smaller capacity. A video recognition circuit 225 receives the digital A/V data to compare the difference between frames for determining whether there is any motion of objects in the monitored area. If the answer is yes, the digital A/V data will be stored into the memory card 204 via a memory card interface 228 to recording occurrence of event; otherwise, no digital data will be stored. It is thus not necessary to keep recording for the whole day, hence saving memory space and power consumption. Finally, the digital video data are compressed into an analog signal by a video encoder circuit 226, and the digital audio data are compressed into an analog signal by an audio CODEC circuit 227. The two analog signals are then simultaneously outputted to an external display 40 via an analog video signal output port and an analog audio signal output port for displaying video and audio of the monitored area. The display 40 can be a LCD, an OLED display, a plasma display, or a CRT display.

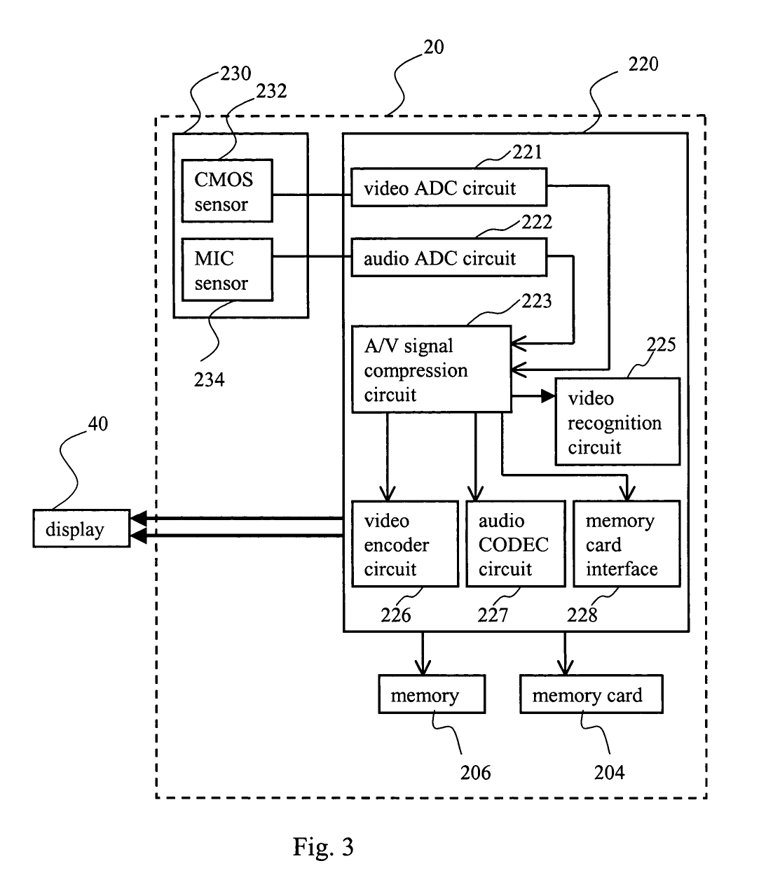

As shown in FIG. 3, the security camera 30 is placed into the digital video recorder 20 in the form of a camera module 230 so that the digital monitor video recorder 20 has a built-in camera (not shown). The camera module 230 has a CMOS sensor 232 and a Microphone 234. The digital video recorder 20 is thus integrally formed to apply to different installation environments. The connection between this camera module 230 and the DSP chip 220 can be accomplished in an analog-to-digital way or a full digital way. The programmable DSP chip 220 can perform signal calibration for the above two ways.

The memory card 204 is a flash memory, which can be a built-in NAND type flash memory or an external flash memory card. The types of the external flash memory card include CompactFlash (CF), Secure Digital (SD), Microdrive (MD), SmartMedia (SM), MagicGate (MG), MultiMediaCard (MMC), Memory Stick (MS), and xD-Picture Card. The memory card interface circuit 228 is integrated into the DSP chip 220 to accomplish a simple structure and a small size as compared to the structure and size of an optical disc drive. Moreover, the memory card 204 has a lifetime of use longer than that of a harddisk drive and a conventional video tape, and is difficult to damage. Besides, the video recognition circuit 225 has the video recognition function. The video recognition PIR circuit 225 can be on another independent chip, e.g., a passive infrared remote (PIR) sensor, which is connected with the DSP chip 220 by means of bus. Because common families have lower requirements for safety than the industry and the military, the video recognition circuit 25 drives the digital video recorder 20 to record only when an event takes place, hence saving memory space and being suitable for common home use. Moreover, a circuit integration design is adopted for the DSP chip 220 to achieve high integrity, low cost, and better reliability. The DSP chip 220 can be mass-produced so that common families can afford.

To sum up, the present invention uses the above flash memory as a storage device of a digital monitor video recorder. The flash memory has a long lifetime of use, can undergo repetitive reads/writes for many times, and is difficult to damage. Moreover, various circuits with different functions are integrated into the same chip to accomplish small size, low cost, and high reliability. It is not necessary to solely depend on strict compatibility of components, hence simplifying the system and making maintenance easy. Therefore, the present invention not only can effectively solve the problems of high price and complex structure of the conventional digital monitor video recorder, but also can provide a digital monitor video recorder suitable for home use to secure safety. The present invention has also the advantages of simple installation and easy maintenance.

Although the present invention has been described with reference to the preferred embodiments thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A digital video recorder connected to at least a security camera for receiving its analog video signal and audio signal, said security camera being installed in a monitored area, said digital video recorder comprising:
at least a storage unit for storage of digital video and audio data; and
a chip having a video signal conversion circuit for converting said analog video signal into a digital video signal, an audio signal conversion circuit for converting said analog audio signal into a digital audio signal, a signal compression circuit for comprising said digital video signal and audio signal into a compressed digital A/V data, and a detection circuit for recognizing motion of objects in said monitored area based on said digital A/V data.

2. The digital video recorder as claimed in claim 1, wherein said storage unit is a built-in flash memory or an external flash memory card.

3. The digital video recorder as claimed in claim 2, wherein said built-in flash memory is of NAND type.

4. The digital video recorder as claimed in claim 2, wherein said external flash memory card is one selected from the group composed of CompactFlash (CF), Secure Digital (SD), Microdrive (MD), SmartMedia (SM), MagicGate (MG), MultiMediaCard (MMC), Memory Stick (MS), and xD-Picture Card.

5. The digital video recorder as claimed in claim 1, wherein said chip further comprises a storage interface for connection with said storage unit.

6. The digital video recorder as claimed in claim 1, wherein said chip is a programmable digital signal processing (DSP) chip.

7. The digital video recorder as claimed in claim 1 further comprising a memory for storage of data accessed by said chip.

8. The digital video recorder as claimed in claim 1, wherein said detection circuit is one selected from the group composed of a built-in video recognition circuit, a passive infrared remote (PIR) sensor circuit, and an external device capable of providing activation mechanism via a General Purpose Input Output (GPIO) interface.

9. The digital video recorder as claimed in claim 8, wherein said external device is an alarm.

10. The digital video recorder as claimed in claim 1, wherein said chip further comprises a USB interface circuit for connection with an external equipment.

11. The digital video recorder as claimed in claim 1, wherein said chip further comprises an video encoding circuit for compressing said digital video signal and converting it into an analog signal.

12. The digital video recorder as claimed in claim 1, wherein said chip further comprises an audio encoding/decoding circuit for mutual conversion of audio between analog and digital forms.

13. The digital video recorder as claimed in claim 1 further comprising an analog video signal input port.

14. The digital video recorder as claimed in claim 1 further comprising an analog audio signal input port.

15. The digital video recorder as claimed in claim 1 further comprising at least a video signal output port connected with at least a display, said display being a flat panel display or a cathode ray tube display for displaying of a digital or analog video signal.

16. The digital video recorder as claimed in claim 15, wherein said flat panel display is one selected from the group composed of an LCD, an OLED display, and a plasma display.

17. The digital video recorder as claimed in claim 1 further comprising at least an audio signal output port.

18. The digital video recorder as claimed in claim 1 further comprising a camcorder module with a video sensor and an audio sensor, said camera module being connected to said chip for providing an A/V signal for said chip.

19. The digital video recorder as claimed in claim 18, wherein said video sensor is a CMOS video sensor.

20. The digital video recorder as claimed in claim 18, wherein said A/V signal is analog or digital.
